(19) United States
(12) Patent Application Publication
(10) Pub. No.: US 2005/0230595 A1
(43) Pub. Date: Oct. 20, 2005

(54) Support device for supporting templates

(76) Inventor: Carmelo Angelo Cortese, Sasso Marconi (IT)

Correspondence Address: MCGLEW & TUTTLE, PC, P.O. BOX 9227, SCARBOROUGH STATION, SCARBOROUGH, NY, 10510-9227, US

(21) Appl. No.: 10/489,981

(22) PCT Filed: Oct. 8, 2003
(86) PCT No.: PCT/IT03/00603

§ 371 Date: Mar. 17, 2004

(30) Foreign Application Priority Data
Nov. 14, 2002 (IT) BO2002A000718

(51) Int. Cl. F16M 1/00

(52) U.S. Cl. 248/678

(57) ABSTRACT

The support device for cutting templates comprises a panel (2) with an essentially rectangular shape and presenting along the longitudinal sides respective raised rims (3) that serve as guides for sliding it into a cutting machine. The longitudinal rims (3) are fitted with an edge (4) that is folded towards the centre of the panel (2), presenting the respective bevels (5) at the opposite ends in the corners. The panel (2) has a front rim (6) produced by folding the same panel (2) in a single piece and destined to function as the support device's handle.

### TECHNICAL FIELD

The following invention regards a support device for cutting templates, destined in particular to be applied in machines for cutting tubular-shaped textile goods.

### BACKGROUND ART

Machines that cut tubular textile goods following suitable outlines in order to produce underwear and similar are currently known. Such machine are constituted substantially by a press, which has a special cutting template or plate applied to the mobile part, with an outline that corresponds to the garment to be produced. The textile goods to be cut are introduced onto the machine's surface and then undergo the action of the press that cuts them using the abovementioned template.

The cutting templates are joined to a support device commonly known as a template holder. According to a known type, the cutting template support device is constituted by a panel obtained from a suitably-shaped metal sheet, as shown as an example in FIG. 5. The sheet is cut according to the required perimeter, for example by laser machines, and then folded in such a way as to form a type of drawer. The drawer panel therefore presents raised rims along the respective sides; the longitudinal rims have an edge folded towards the centre of the panel, in order to form a type of guide for being slid onto the press. The panel also has a grip handle fixed on a corresponding transversal rim, for example by means of welding. The cutting template is fixed on the outer face of the support panel.

The abovementioned cutting template support devices have various inconveniences that make its use expensive and unpractical. In particular, the support devices of the known type have a relatively high price, due primarily to the material from which they are made and the time and work processes required to manufacture them. It should be remembered that such support devices represent a consumable material for the machine as they must be replaced with a certain frequency, due primarily to the wear to which they are subject, and therefore in time related costs can reach a somewhat high overall value.

The template holder devices of the known type are also awkward to use and can be dangerous for those operating them as they require manual handling in order to be introduced into the machine. In particular, the corners of the abovementioned longitudinal rims represent a potential hazard.

### DISCLOSURE OF INVENTION

The aim of the present invention is to resolve the abovementioned drawbacks by devising a support device for cutting templates that makes it possible to considerably reduce production costs.

Within the ambit of this task, a further aim of the present invention is to provide a support device for cutting templates that is easy to use and safe for the operator.

A further aim of the invention is that of providing a support device that is of simple conception, certainly reliable function and versatile in use.

The abovementioned objectives can be achieved by this present support device for cutting templates characterized in that it comprises a substantially rectangular-shaped panel, obtained by folding a metal sheet flat according to a predetermined shaped profile and presenting along the respective longitudinal sides respective raised rims, serving as guides for sliding it into the cutting machine, characterized by the fact that on said metal sheet, in the outer corners of opposite portions destined to form said longitudinal rims, there are respective bevels that reduce the perimeter of said shaped outline of the metal sheet, said longitudinal rims being respectively fitted with an edge folded towards the centre of said panel, presenting said bevels in the corners of the opposite ends.

### BRIEF DESCRIPTION OF THE DRAWINGS

Description details of the invention shall be further evident in the illustrations of a preferred type of a support device for cutting templates, in the guideline drawings attached and wherein:

FIG. 1 illustrates a prospective view of the support device for cutting templates in object;

FIG. 2 illustrates a lateral view of said support device;

FIG. 3 illustrates a corresponding plan view;

FIG. 4 shows a view of the plan development of a shaped sheet of metal for the creation of the support device in object;

FIG. 5 illustrates a corresponding view of the plan development of a conventional support device.

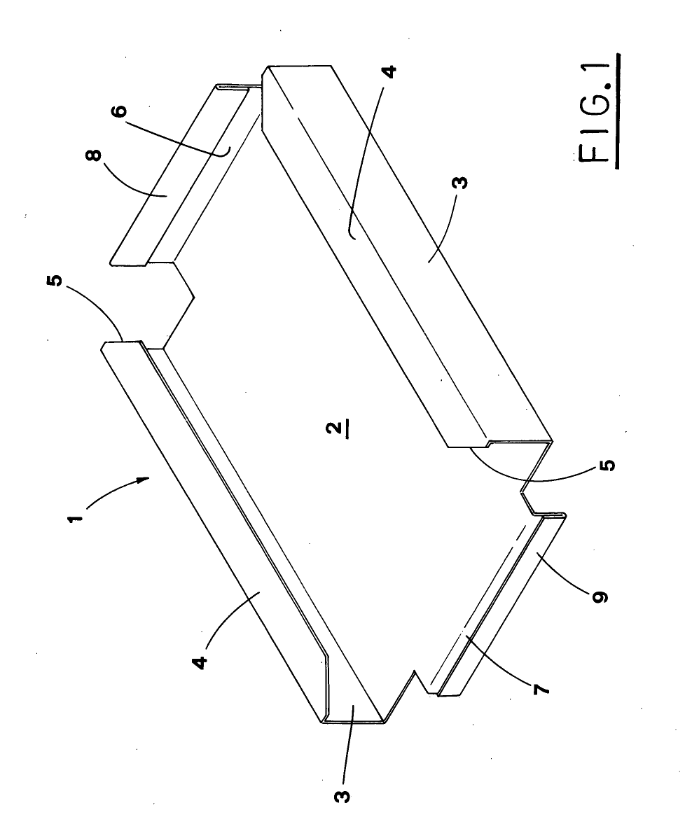

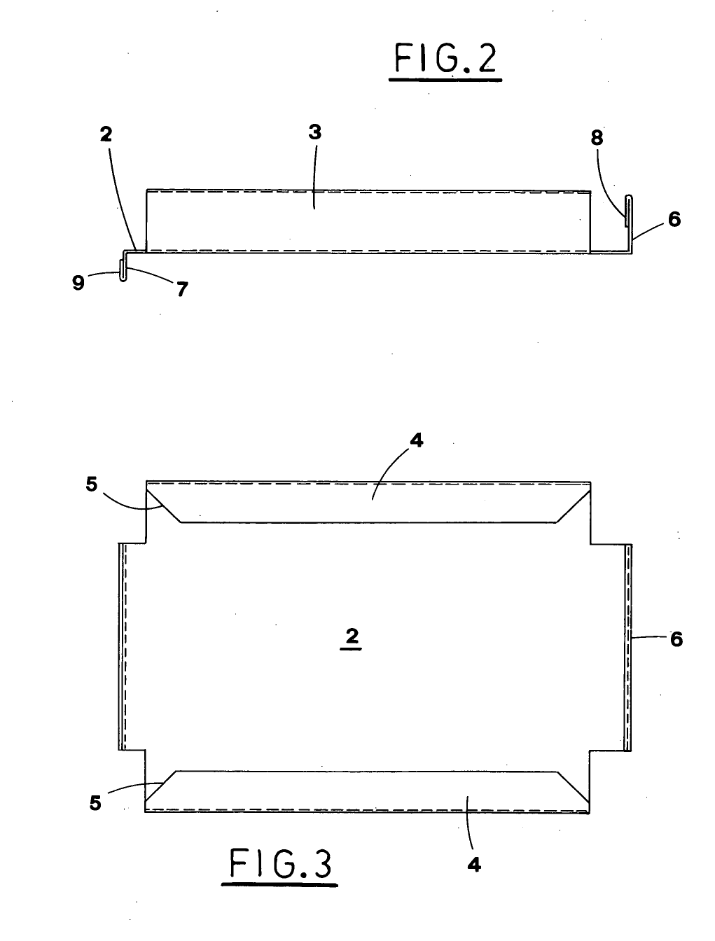

### MODES FOR CARRYING OUT THE INVENTION

With particular reference to the figures, 1 refers to the support device for cutting templates, destined to be applied in a machine for cutting tubular-shaped textile products.

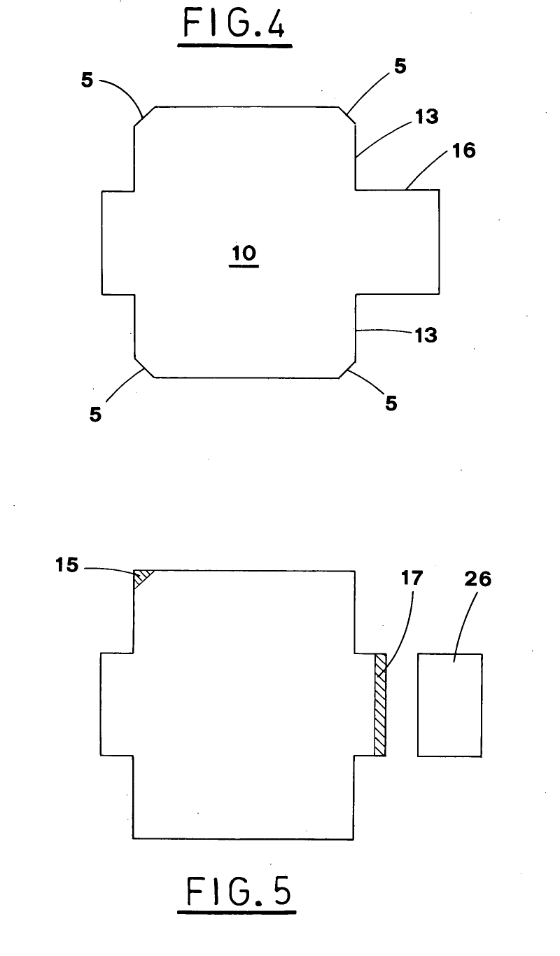

The cutting template support device is constituted by a panel 2 obtained from a sheet of metal 10 such as stainless steel, suitably shaped according to the outline shown in FIG. 4; the metal sheet 10 is subsequently folded in such a way as to form a sort of drawer. In particular, the panel 2 has a substantially rectangular shape and along the longitudinal sides has raised rims 3; the longitudinal rims 3 have an edge 4 folded towards the centre of the panel 2, in such a way as to serve as a guide for sliding it onto the press.

The edges 4 of the longitudinal rims 3 have respective bevels 5 at the respective ends. The bevels 5 cut the outer corners of the edges 4 at an angle of 45°.

Along the transversal sides, on the other hand, the panel 2 presents further rims 6, 7 folded perpendicularly to the plane of the same panel 2. In particular, the front rim 6 is raised in the same direction as the longitudinal rims 3, in other words upwards when in an operative set-up on the press, and is destined to act as a handle of the support device. The frontal rim 6 usefully presents a crushed fold stretch 8, obtained by folding a marginal portion on to the inner face of the same rim 6.

The rear rim 7 is folded downwards, in other words from the opposite side of the panel 2 to the rims 3 and 6. The rear rim 7 in turn presents a stretch of crushed fold 9, obtained by a marginal portion on to the outer face of the same rim 7.

It should be pointed out that the longitudinal rims 3 and the transversal rims 6, 7 do not stretch for the entire length of the corresponding sides of the panel 2, as they do not affect the corner area of the panel 2. Usefully it is foreseen that these corner areas be removed, as shown in FIG. 3.

The functioning of the support device for cutting templates is easily understandable from the above description.

The support device for cutting templates achieves the purpose of creating a considerable reduction in production costs, in particular thanks to considerable material savings and an optimisation of the work processes required.

This can be obtained essentially thanks to the production of the bevels 5 at the ends of the portions 13 of the metal sheet 10 destined to form the edge 4 of the longitudinal rims 3 (see FIG. 4). Such bevels 5 determine a considerable reduction in the material used, preferably stainless steel, as can be seen in comparison with in the plan development drawing of a conventional template holder illustrated in FIG. 5. For greater clarity, in FIG. 5 the dotted area 15 represents the portion of metal sheet of conventional template holders that are removed in the template holder in object, in correspondence with each of the four corners of the longitudinal rims, thanks to the creation of the bevels 5 and therefore the relative greater consumption of material in the conventional template holders.

This saving of material is obviously more significant considering the high number of template holders normally used by sector industries and the high frequency with which they must be replaced.

The creation of the bevels 5 also has the advantage of considerably reducing the time required for the sheet 10 cutting operation, as the cutting organs, such as lasers, have to cover a shorter perimetral length than that of conventional template holders.

It should be pointed out that the bevels 5 also have the purpose of eliminating a cutting part from the device's grip area by the operator, so as to reduce the risk of cuts and the like. In addition to reducing production costs and improving the template holder device's functionality, it also contributes to producing the grip handle in a single piece with the panel 2, by the folding of a relative portion 16 of the metal sheet 10 (see again FIG. 4).

This brings about an obvious simplification of the production process, requiring only one process against the two required for conventional template holders, in which the grip handle is obtained from a separate piece of metal sheet, indicated with 26 in FIG. 5, which can subsequently be folded and fixed by welding to a corresponding transversal rim.

The welding of the grip handle also entails the overlapping of the two parts to be joined, which determines further greater consumption of material than the solution in object, in which the handle is produced in a single piece with panel 2. For greater clarity, in FIG. 5 the dotted area 17, represents the overlapping portion of the two parts to be welded for the production of the grip handle in conventional template holders and therefore the relative greater consumption of materials.

Materials adopted for the actual realisation of the invention, as well as their shapes and sizes can be various, depending on the requirements.

1. Support device for cutting templates of the type comprising a panel (2) with a substantially rectangular shape, obtained by folding starting from a sheet of metal (10) developed flat following a predetermined shaped outline and presenting along the respective longitudinal sides raised rims (3) that serve as a guide for sliding in to the cutting machine, characterized in that said panel (2) presents a frontal rim (6) made by folding in a single piece with the same panel (2) and destined to function as a handle of the support device.

2. The device according to claim 1, characterized in that on said metal sheet (10) there are respective bevels (5) used to reduce the perimeter of said shaped outline of the metal sheet (10), in correspondence with the outer corners of opposite portions (13) destined to form said longitudinal rims (3), said longitudinal rims (3) being respectively fitted with an edge (4) folded towards the centre of said panel (2), presenting said bevels (5) at the opposite extremities, in correspondence with said corners.

3. The device according to claim 1, characterized in that said frontal rim (6) is raised in the same direction as the two longitudinal rims (3), upwards when set-up for use on said cutting machine.

4. The device according to claim 1, characterized in that said frontal rim (6) has a crushed folded stretch (8), obtained by folding a marginal portion on to the inner face of the same rim (6).

5. The device according to claim 2, characterized in that said bevels (5) cut the outer corners of said edge (4) of the longitudinal rims (3) at an angle of 45°.

6. The device according to claim 1, characterized in that said panel (2) has a rear rim (7) folded from the opposite side than the longitudinal rims (3).

7. The device according to claim 6, characterized in that said rear rim (7) has a crushed fold stretch (9), obtained by folding a marginal portion on to the external face of the same rim (7).

8. The device according to claim 1, characterized in that said longitudinal rims (3) and said frontal rim (6) do not stretch for the entire length of the corresponding sides of said panel (2), said rims (3, 6) not involving the corner areas of the same panel (2).

9. The device according to claim 8, characterized in that said corner area of said panel (2) are removed.
